(19) United States
(12) Patent Application Publication
(10) Pub. No.: US 2022/0058651 A1
(43) Pub. Date: Feb. 24, 2022

(54) AUTHENTICATION OF FINANCIAL TRANSACTION

(71) Applicant: Wells Fargo Bank, N.A., San Francisco, CA (US)

(72) Inventor: Paul Vittimberga, Oakland, CA (US)

(21) Appl. No.: 15/391,649

(22) Filed: Dec. 27, 2016

(51) Int. Cl. G06Q 20/40; G06Q 10/06; G06F 17/30

(52) U.S. Cl. CPC G06Q 20/4014; G06F 17/30424; G06Q 10/067

(57) ABSTRACT

Various examples are directed to computer-implemented systems and methods for authentication of financial transactions. The method includes receiving a request from an initiation point to authenticate a user to perform a transaction, and obtaining device data gathered by internet-enabled devices used by the user. Third-party data is received from a third party in response to a third-party authorization inquiry, and a processor located at a decision point uses the device data and the third-party data to authenticate the user for the transaction.

### TECHNICAL FIELD

Embodiments described herein generally relate to user authentication and, for example and without limitation, to systems and methods for improved authentication and authorization of financial transactions.

### BACKGROUND

User authentication is important to deter fraud and verify the identity of a user who wishes to access a secured resource. Examples of user authentication include the use of a username and password combination to access an online service. Authorization is a decision to allow or decline access to a secured resource based on user authentication and other factors.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not of limitation, in the figures of the accompanying drawings, in which;

FIG. 1 illustrates a flowchart of an example method of transaction authorization;

FIG. 2 illustrates a flowchart of an example method of identity authentication;

FIG. 3 illustrates an example embodiment of a computing device used by a user to initiate a transaction that requires authorization;

FIG. 4 illustrates an example embodiment of a computing device used to authorize transactions; and

FIG. 5 is a block diagram of a machine in the example form of a computer system within which a set of instructions can be executed, for causing the machine to perform any one or more of the methodologies discussed herein.

### DETAILED DESCRIPTION

User authentication is important to deter fraud and verify the identity of a user who wishes to access a secured resource. Examples of user authentication include the use of a username and password combination to access an online service. A user's request to perform a financial transaction may be initiated at an initiation point, such as the user's financial institution, another financial institution, a merchant location, another venue, or by an individual. In order to authenticate the user and reduce financial risk in performing the transaction the initiating point may request an authorization for the transaction from the user's financial institution. This request may be delivered directly or by an intermediary network to the authentication decision point of the account holder's financial institution, in various embodiments. The decision point applies rules in evaluating data provided in the authorization request as well as additional information regarding the user (or account holder) to determine whether to authorize or decline the transaction. The decision point may then respond to the initiating point with the decision, in various embodiments.

In practice, there are fraudulent transactions that have attributes of a valid transaction and therefore result in the decision point authorizing fraudulent transactions. There are also valid transactions that have attributes of a fraudulent transaction and therefore result in the decision point declining valid transactions. A limitation of existing decision point technology is the available data upon which to build decision models and make authorization decisions. For example, available decision data may include the locations, dollar amounts, and frequency of transactions made by the account holder in the past. A valid transaction outside of the account holder's normal pattern may be declined as fraudulent if it is in a new location, for an unusual dollar amount or outside of the normal pattern of transaction frequency. In order to prevent the declining of valid transactions, financial institutions may provide a mechanism for account holders to advise the financial institution of anticipated unusual activity—for example, the ability to report anticipated travel plans. Notwithstanding this additional data, financial institutions still face significant obstacles in making accurate authorization decisions.

The present subject matter employs data gathered from Internet-enabled devices used by the user to improve authorization decisions, or user activity on the user's internet-enabled devices. Devices may include but are not limited to desktop computers, laptop computers, tablet computers, cell phones, and wearable devices. The data that may be gathered from such devices (also referred to herein as device data) may include, but is not limited to, personal profile information, user name, email address and password, birthday, gender, phone number, location (both current and historical data), device hardware and firmware, and installed software. For example if the user device has financial institution software installed (such as a mobile wallet application in one example), a unique identifier for the instance of the account holder's financial institution's software is included as device data. Device data may include interaction data such as web search terms, websites visited, videos viewed, advertisements selected, and IP address and cookie data. Device data may further include user content on device or associated cloud services, such as emails, contacts, calendar events, photos, videos and documents.

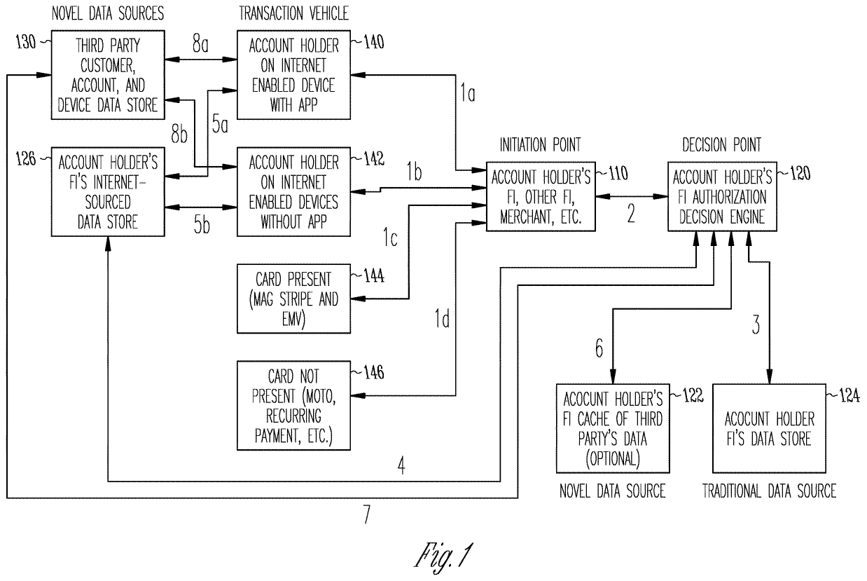

Additional device data that may be gathered includes data from application software loaded onto device. For example, a device user may install application software onto one or more of his/her devices, such as software on a laptop computer or an “app” on a tablet or mobile device. When software is loaded onto the device and/or from time to time, the user may provide implicit or explicit consent to allow the software and, by extension, the provider of the software to access, retrieve and store some or all device data. FIG. 1 includes devices with a software application installed 140 and devices that do not have a software application installed 142. In various embodiments, device data for a device with an installed application includes data made available by a device or an application loaded onto a device and communicated via an internet communications protocol.

A device user may utilize a web browser on a device to access a website controlled directly or indirectly by an entity. The web browser on the device may provide a limited set of device data to the entity; it may also allow the entity to store a small amount of data on the user's device in the form of a cookie. Certain device data, such as global positioning system (GPS) location, may be available to the entity with explicit consent of the user, granted through the browser for each session and potentially retained as a preference for multiple sessions. If the user consents to adding a browser extension provided by the entity, then more device data will be available to the institution. However, it will still be a more limited set than could be provided by application software installed onto the device by the entity. In various embodiments, device data for a device without an installed application includes data made available by a device and communicated via an internet communications protocol.

According to various embodiments, selected elements of device data can be combined to create a fingerprint. The fingerprint, such as a device fingerprint, machine fingerprint, or browser fingerprint, includes information collected about a remote computing device for the purpose of user or device identification. These fingerprints can be used to fully or partially identify individual users or devices, even when cookies are turned off, according to various embodiments.

The present subject matter may employ additional device data known to a financial institution, in various embodiments. The financial institution may have account holders that use a device to access a website controlled directly or indirectly by the financial institution. The financial institution may capture and retain device data with each web interaction in a data store, as shown at 126 in FIG. 1. A financial institution may also have users that use an application provided by the financial institution. In this case, the financial institution may capture and retain device data during interactions with the customer, upon a schedule, or on demand.

In various embodiments, the present subject matter may use device data known to a third party data source. A third party may have users that use a device to access a website controlled directly or indirectly by the third party. The third party may capture and retain device data with each web interaction, as shown at 130 in FIG. 1. A third party may also have users that use an application provided by the third party. In this case, the third party may capture and retain device data during interactions with the customer, upon a schedule, or on demand.

In various embodiments, the present subject matter may use customer profile, account, and other information stored by a third party that is not necessarily device data. This data would also be included in 130 in FIG. 1. Such data may include information that was created on one or more devices but is retained in a centralized manner that is not necessarily device-specific, such as emails, contacts, calendar events, photos, videos and documents. It may also include information about customer preferences, history and demographics or other customer attributes.

### Transaction Authorization

FIG. 1 illustrates a flowchart of an example method of transaction authorization, according to various embodiments of the present subject matter. The method includes receiving at a decision point 120 a request 2 from an initiation point 110 to authorize a transaction, and obtaining device data 122, 126, 130 gathered by internet-enabled devices used by the user. The transaction request begins at 1a, 1b, 1c, 1d when transaction vehicle 140, 142, 144, 146 respectively attempts to perform a transaction at or with the initiation point 110. The transaction vehicles include account holder internet enabled devices 140 with the financial institution or third party's application installed, account holder internet enabled devices 142 without the applications installed, a credit card transaction 144 with card used such as magnetic stripe and EMV (Europay, Mastercard, and Visa), and a credit card transaction 146 without the card present such as recurring payments or MOTO (mail order/telephone order).

Upon receipt of an authorization request from the initiation point 110, the financial institution may access the traditional sources of authentication data 124, such as the account holder's historical transaction frequency, dollar amount, location of initiation point, and information about variations from typical behavior that the customer may have communicated, such as travel plans or intent to make a large purchase. The decision point's access of traditional data stored by a financial institution is shown by arrow 3 in FIG. 1, in an embodiment.

In various embodiments, further intelligence may be gained by comparing the transaction information received in the authorization request and the account holder's traditional data with device data 126 that has been stored by the financial institution, The decision point's access of device data stored by financial institution is shown by arrow 4 in FIG. 1. Where feasible, more information can be garnered by interrogating in real-time device data 126 from one or all available devices that have ever been used by the account holder to access internet sites controlled directly or indirectly by the financial institution and which are currently reachable via the Internet by the financial institution, as shown by arrows 5a and 5b. Arrow 5a in FIG. 1 illustrates access to and receipt from a device with an application from the financial institution installed 140, and arrow 5b illustrates access to and receipt from a device that does not have an application from the financial institution installed 142. In various embodiments, device 140 or device 142 can be the transaction vehicle.

Third-party data 130 is received from a third party, such as a data aggregator, in response to an inquiry as shown at arrow 7 in FIG. 1. The processor located at the decision point 120 uses the third-party data to enhance the quality of the authorization decision as to whether to authorize or decline the transaction requested by the initiation point. Where feasible, more information can be garnered by interrogating in real-time device data 130 from one or all available devices that have been used to access internet sites controlled directly or indirectly by the third party, that have ever been used by the account holder and which are currently reachable via the Internet by the third party with access shown in arrows 8a and 8b. Arrow 8a in FIG. 1 illustrates access to and data receipt from a device with an application from the third party installed 140, and arrow 8b illustrates access to and data receipt from a device that does not have an application from the third party installed 142. In various embodiments, device 140 or device 142 can be the transaction vehicle.

In addition, as part of the authentication of the transaction, the financial institution may access device data or other customer data captured by a third party and cached on the financial institution's systems. This is data captured by a third party and shared prospectively with the account holder's financial institution 122, in various embodiments. The decision point's access of cached third party data stored by the financial institution is shown by arrow 6 in FIG. 1.

The decision point's request for third party data is shown by arrow 7 in FIG. 1. This query should include a means of matching (such as a match key) the account holder to an individual known to the third party and to the device or devices used by that individual. This match key can be a jointly known piece of identifying information, such as an email address, social security number, mailing address, or a financial account routing number and account number combination. In various embodiments, the match key can be any device information, such as unique identifiers for the instances of the financial institution's software or other software installed on the account holder's devices. Other device information useful for this purpose may be known locations or IP addresses of the devices at present or at certain times in the past, device EIN/MEID/IMAC (unique device serial numbers assigned by the manufacturer), other device identifiers, or device fingerprints for one or more of the account holder's devices.

A match between the account holder to an individual known to the party and to the device or devices used by that individual will be stronger if there are more matching pieces of identifying information. Some matching information, such as a physical or email address, may be less indicative of having identified the same individual across organizations than other information, such as a matching social security number or device fingerprint. Some non-matching information may not have a strong negative correlation to an identity match, for example, a phone number or device ID where a given individual may have many and use them for different purposes. Other non-matching information, such as a social security number, may be strongly correlated with a mismatch. When the third party tries to find a match to an individual with the data provided by the financial institution, there may be only one unique individual known to the third party that is a close match or there may be more than one. In the latter case, the best match may be considered less strong given the proximity of other alternatives.

In order to consider multiple pieces of information in finding a matching individual and representing the strength of the match the third party, the financial institution or the parties in collaboration may compute and evaluate an identity match score. While the number if possible factors and their associated weightings are limitless, an example of the matching score may be a weighted combination of the email match as a binary factor, the device fingerprint match as an analog factor, and an address match as a discrete factor. For example, in one embodiment of an identity match score, the identity match probability, IM, is computed as follows:

IM=x*(E)+y*(DF)+z*(A), where

E, DF, and A are positive or negative rational numbers that are independent variables or predictors that have been found to be correlated to the likelihood of a valid match through model development as described below or through other means.

x, y, and z are constants that are determined through model development as described below or through other means. In an embodiment, x, y, and z are weights that determine the influence of each of the independent variable terms, E, DF, and A, respectively.

E is an integer with a value of 1 when a valid primary email match exists and 0 when it does not

DF is a rational number with a value between 0 and 1, inclusive, which indicates the strength of the device fingerprint match,

A is an integer with a value of 2 when the primary physical address is a match, 1 when at least one physical address from the third party and the financial institution match and 0 when no physical addresses matches.

An example calculation may be as follows where the value of E, DF, and A have previously been determined to be 5.9, 7 and 3 respectively. In this example, the primary email addresses match, the device fingerprint is an 83% match, and there is a matching physical address that is not the primary address for either the third-party data provider or the financial institution.

In this example, M=5.9*(1)+7*(0.83)+3*(1)=14.71 which may also be expressed as a percent of the possible or probable range of values. Other identity match calculations can be performed without departing from the scope of the present subject matter.

In various embodiments, matching identities and/or the identity match score may be determined previously and/or periodically, for some or all likely transaction users, in order to speed the real-time authorization process.

When the financial institution sends a query to the third party, the query may include the name of the merchant in question, in an embodiment. In addition or in the alternative, the query may include an identifier of the type of merchant. In the latter case, the financial institution or third party may need to translate the merchant taxonomy of the financial institutions to those of the third party. In the example where a search engine (such as Google) was acting as a third party, the financial institution or search engine may need to translate the financial institution's merchant category code and merchant category group (merchant type) to the search engine's product taxonomy. Upon receipt of a query from the financial institution, the third party may access its own store of customer or account data. In addition, further information may be gained by comparing the query information with device data that has been stored by the third party.

In conjunction with an identity match and associated identity match (IM) score, the parties will use all available customer, account and device data to determine if the transaction that is being requested is consistent with the data. This assessment relies in part on the traditional factors used to make authorization decision, but the assessment can be enhanced by using the third party's data related to the transaction, in an embodiment. The third party's data can include either the third party's account data or other customer attributes, or the third party's device data, both shown in 130. The financial institution and third party's device data may be considered separately or in conjunction. For example, an evaluation may be made of the location of the user's devices at the time of the transaction or historically in comparison to the location of the requested transaction, with said consideration being important for device-based transactions (140, 142) and card present transactions (144) but less important for card not present transactions (146). In the case of device-based transactions (140, 142) the financial institution, the third party or both may be able to contact the device in real-time to obtain further information. Any device or customer data may be useful in the assessment of the transaction, such as account profile details, Web pages visited, flies or images stored on devices or in a cloud location, text messages, and email content in various embodiments.

In order to consider multiple pieces of information in determining whether the transaction is consistent with the user's circumstances, the third party, the financial institution or the parties in collaboration may compute and evaluate a transaction consistency score, in various embodiments. While the number if possible factors and their associated weightings are limitless, an example of the transaction consistency score may be a weighted combination of the percent of user's mobile phone type devices currently located within 100 yards of the merchant location, and the number of Web sites visited by the user in the last 30 days that feature the type of product or products that are being purchased in the transaction under evaluation. For example, in one embodiment of a transaction consistency score, the transaction consistency, TC, is computed as follows:

TC=q*(L)+r*(W), where

q and r are constants that are determined through model development as described below or though other means. In an embodiment, they are weights that determine the influence of each of the independent variable terms, L and W.

L and W are numbers that are independent variables or predictors that have been found to be correlated to the likelihood of a valid match through model development as described below or through other means.

L is a percent of user's mobile phone-type devices currently located within 100 yards of the merchant location expressed as rational number from 0 to 1.

W is an integer corresponding to the number of Web sites visited by the user in the last 30 days that feature the type of product or products that are being purchased in the transaction under evaluation. W has a minimum value of zero and in this example has a maximum value of 30.

An example calculation may be as follows, where the value of L and W have previously been determined to be 4 and 0.23 respectively. In this example, the user has two mobile phones, one of which is located within 100 yards of the transaction location. The user has visited 15 unique Web pages that contain information about the same type of products as are included in the transaction under evaluation.

TC=4*(0.50)+0.23*(15)=5.45 which may also be expressed as a percent of the possible or probable range of values. Other transaction consistency calculations can be performed without departing from the scope of the present subject matter.

In various embodiments, the transaction consistency score may be determined previously and/or periodically for some or all likely transaction users in order to speed the real-time authorization process. This previous determination is only partially possible if the score depends on real-time data from the third party, as was the case with the L value in the above example. The determination calculate transaction consistency scores for all or some of the user's likely transaction categories. While data would be processed for categories for which no transaction may ever be received, such processing could be done in a batch mode and could remove time-consuming steps from the real-time processes involved in the authorization decision and response, in various embodiments.

The identity match (IM) score or the transaction consistency (TC) score may be calculated by the third party using information provided by the financial institution with the score being returned to the financial institution along the return path of arrow 4 in FIG. 1, in an embodiment. The scores may be calculated by the financial institution using information returned by the third party along the return path of arrow 4 in FIG. 1 in conjunction with stored third party data, shown as 122 in FIG. 1, in an embodiment. A partial score may be calculated by the third party and returned to the financial institution to be combined with other independent variables and weights calculated by the financial institution in order to create the compete score, in various embodiments. Other scores or indicators can be used without departing from the scope of the present subject matter.

In various embodiments, one or more models can be developed by the present subject matter such as the identity match (IM) score and transaction consistency (TC) score as described above. This model development may present challenges if entities (such as the financial institution and third party) are constrained for sharing customer data with the other. In order to allow for model development, the parties may share data, either directly or through a trusted processor, that does not include personally identifiable information but does include the potentially useful modelling variables and values. In various embodiments, the authorization model within the decision point 120 is updated to include all of the potential sources of data that may now available to the financial institution. This model incorporates the identity match (IM) score and the transaction consistency (TC) score described above. In various embodiments, using the device data and the third-party data to authenticate the user for the transaction includes developing a model that incorporates a generated identity match score and a received identity match score. Using the device data and the third-party data to authenticate the user for the transaction includes developing a model that incorporates and a generated transaction consistency score and a received transaction consistency score, in various embodiments.

The relationship between one or more third parties and one or more financial institutions can be managed through an interchange, in an embodiment. This interchange can accept transaction information requests from a financial institution and distribute the request to one or more third parties based on a number of factors. Such factors can include the existence of pre-arranged relationships between the financial institution and the third party, the likelihood that the third party has data relevant to the request, and the cost that is charged by the third party to fulfill the request. This interchange can establish and publish one or more application programming interfaces for the use of the parties. It may also provide a mechanism for pricing or bidding on third party data by the financial institutions in a real-time manner, in various embodiments.

In one example, the use of the present subject matter involves a user credit card transaction. In the example, Jane Smith is a credit card account holder of Acme Bank. An authorization request is sent to Acme Bank's decision point by Big Truck Rentals in Dallas, Tex. for Jane's credit card. The dollar amount of the transaction is significantly larger than Jane's typical small-dollar purchases and outside of her normal transaction geography. Acme Bank's decision point retrieves Jane's account transaction history that indicates that the transaction may be fraudulent since it is out of pattern for Jane. The decision point interrogates Acme Bank's device data store and finds that Jane logged into the Acme Bank website from a short-term rental computer at the Dallas airport earlier in the morning and that her cell phone's GPS currently indicates a location within 100 yards of the Big Truck Rentals office in Dallas. Jane's desktop computer is not reachable at her home in California but had been online two days prior.

In addition, the Decision Point may send a query to a search engine such as Google, a third party. This query sends identifying information about the transaction, merchant, and merchant location. It also includes identifying information about Jane, such as her email address, the current GPS location of her cell phone (or other location information) and the IP address of her home computer from two days prior. Google is able to identify Jane with a high probability even though the email address does not match (Jane uses a different email provider). The GPS location and device fingerprint of Jane's cell phone both match closely to those sent from Acme Bank. In addition, the IP address Google last recorded for Jane's home computer, although recorded on a different day and having a different host, shares the same network and approximate geographic location as was sent from Acme Bank. Although Google does not share the device data from its database(s) with Acme Bank, Google knows that Jane has been shopping for rental trucks in Dallas and purchased a flight to Dallas departing the day before using Google wallet and a different bank's credit card. Consequently, Google returns a high third-party transaction consistency (TC) score. In this example, Google also returns a high identity match (IM) score since there were many points of commonality between the identifying information sent in the query and those that Google had stored or was able to access in real-time. On balance, the Acme Bank decision point determines that the transaction is valid and returns an approval to Big Truck Rentals, in this embodiment. The additional sources of data used by the present subject matter for authentication decisions improves the accuracy of the decisions, reducing false results and improving transaction throughput.

### Identity Authentication

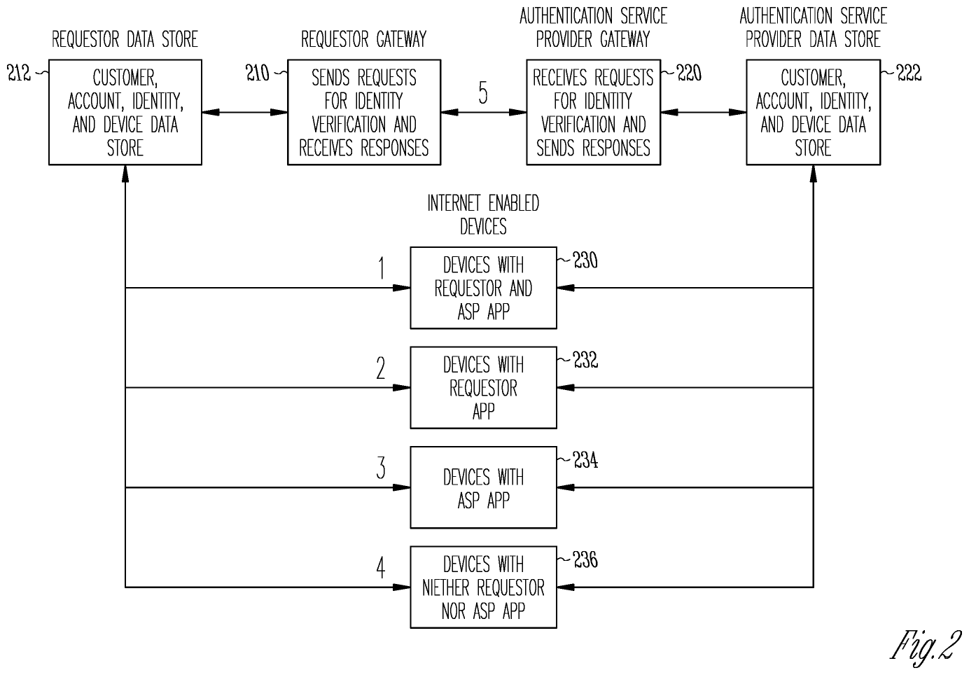

Various embodiments of the present subject matter include a reverse model with the financial institution or similar entity providing authentication service, or acting as an identity authentication service provider (ASP). FIG. 2 illustrates a flowchart of an example method of identity authentication. Often a third party will have substantial information about a customer but will not know that customer's personal information, credit worthiness, or other useful attributes. In various embodiments, the third party is the requestor 210 and the financial institution, credit bureau, or other repository 220 acts as the authenticator of identity, credit worthiness, or other useful attributes. Thus, the requestor 210 has the ability to benefit from not only to their own data store 212 of user information for the authentication decision, but also the data store 222 of the ASP. The data can be obtained from various internet enabled devices of the user, including devices with the third party/requestor's application installed 232, devices with the requester's application and the ASP's application installed 230, devices with the ASP's application installed 234, and devices with neither requestor or ASP's application installed 236.

Other useful attributes that may be provided by the ASP can include the credit worthiness or risk rating of the individual or entity. In addition, other useful attributes may include whether individual or entity that is subject to currency, transaction or other restrictions according to U.S. sanctions administered and enforced by the U.S. Department of the Treasury's Office of Foreign Assets Control (OFAC), as well as sanctions imposed by other countries. An automotive insurance company, for example, acting as an ASP might be able to provide driving and accident history to the requestor. As an example, this information would be useful for a ride-sharing company, such as Uber, to assess the qualifications of a prospective new driver.

Business entities often maintain an online relationship with their individual and business customers by offering Web pages for their customers to visit and application software for mobile, tablet and desktop computing devices for their customers to install and use. Such entities use various methods such as tracking cookies to track their customers' device-based activity. Although these entities are able to capture extensive data about each customer, the actual identity of the customer often remains either unknown to the entity or alleged by the customer but un-authenticated by the entity.

Unlike most other entities, financial institutions and a limited set of other governmental and non-governmental entities verify the identity of each customer as required by law or in accordance with their operating policies and procedures. These policies and procedures for verifying customer identity are known as a Customer Identification Program (CIP). Maintaining a CIP is mandated for financial institutions by the U.S. government, and can be technically challenging and expensive. Entities with few or no customer-facing physical locations have no way to meet a customer in-person to verify an individual's identity or business ownership in a manner consistent with CIP best practices. Even for entities with a broad-ranging set of locations, the cost of maintaining a CIP program can prohibitive. Policies and procedures are developed and staff trained, and systems must be able to capture and securely store highly-confidential customer data, In addition, customers are often unwilling to trust all but a select few entities with their confidential information. There is good reason for customer mistrust—breaches of insecure systems or theft of data by improperly screened employees are frequently in the news.

Businesses that do not maintain a CIP may wish to establish or authenticate the true identify of their customers. This authentication may be for a real person or may establish that real person's relationship as an owner, employee, trustee or other for an entity such as a corporation, partnership, trust, estate, or any other entity recognized as a legal person. The present subject matter describes a method in which such businesses without a CIP can request identity establishment or authentication (hereafter “authentication”) from an entity that employs a CIP. For the purposes of the present subject matter, the business trying to authenticate the identity of their customer is the “requester” and the entity providing the authentication is the authentication service provider or “ASP.”

The present subject matter relates to employing data gathered by both the Requester and ASP from Internet-connected devices used by an individual. Devices may include but are not limited to desktop computers, laptop computer, tablet computers, and cell phones. The data that may be gathered from such devices (device data) may include, but is not limited to: personal profile information such as name, email address and password, birthday, gender, phone number, and country; device data such as the individual's current location (implied by the location of a device), historical locations, device hardware and firmware, installed software, unique identifiers for the instance of the account holder's financial institution's software, and device fingerprint derived from the unique configuration of hardware, software and data; interaction data such as web search terms, websites visited, videos viewed, ads selected, and IP address and cookie data; and content on devices or associated cloud services, such as emails, contacts, calendar events, photos and videos, and documents.

In various embodiments, a device user may install application software onto one or more of his/her devices, such as software on a laptop computer or an “app” on a tablet or mobile device. When software is loaded onto the device and/or from time to time, the user may provide implicit or explicit consent to allow the software and, by extension, the provider of the software to access, retrieve and store some or all device data including data gathered by sensors (e.g., GPS, accelerometer, finger print readers) of the device. The apps can retrieve identifiers such as an identifier for the unique instance of the requester and ASP software installed on the device. Apps can write or read unique tokens or other artifact placed onto the device. They can also read, cache, and forward or deliver upon request the device fingerprint, the location, IP address, or virtually any other device data, in various embodiments.

A device user may use a web browser on the device to access a web site controlled directly or indirectly by an entity. The web browser on the device may provide a limited set of device data to the entity; it may also allow the entity to store a small amount of data on the user's device in the form of a cookie or other tokens. Certain device data, such as location, may be available to the entity through the web browser. Many browsers have privacy settings that provide the device user with control over which data may be shared and with which parties. For example, www.sitea.com may be designated a trusted site able to receive location data whereas www.siteb.com may not. Sometimes permission is requested by the web browser on a case-by-case basis, by asking a question such as, “SiteC would like you to share your location for this session. Please select ‘Agree’ or ‘Don't Agree.’” More comprehensive data can be accessed through the web browser if the device user agrees to add a small piece of software that is provided by an entity; forms of such software include but are not limited to browser extensions, web applications and browser plug-ins. Even with this additional software, the data available to the entity is more limited than could be provided by application software running outside of the browser that is provided by the entity and installed onto the device.

A device with one or more apps from the requestor and one or more apps from the ASP provides a superior source of device data. The requestor and ASP apps can conduct mutual authentication, providing virtual certainty that both requestor and ASP are referring to the same device, in various embodiments. This authentication can be through a pre-arranged exchange of cryptographic keys. Alternatively, each app can validate certain attributes of the other as alleged by the provider of the application. Each can also independently capture a device fingerprint for comparison. An interrogation of device data or a mutual authentication between requestor and ASP apps can be done on demand and in virtual real-time. Alternatively, captured device data can be stored and includes a time stamp. In this case, the utility of device data may diminish or expire after a certain period of time.

Where only one party's app is loaded onto a device, the range of data that can be collected is more limited for the party without an app. The party without the app can gather information from browser interactions with the device and may still be able to create a reasonably strong device fingerprint. The party with the app can gather virtually all device data. The opportunity for secure mutual authentication is more limited; however, it is possible to determine with a very high degree of confidence that both the requestor and ASP are referring to the same device by comparing the totality of device data available to the requestor and ASP.

Where neither party has an app loaded onto the device, the available data is limited to that which can be gathered from browser-based interactions. Despite this, both parties are able to create a reasonably strong device fingerprint. It is possible to determine with a very high degree of confidence that both the requestor and ASP are referring to the same device by comparing the totality of device data available to the requestor and ASP. Both the requestor and the ASP can capture and cache device data periodically, in various embodiments. This data can be stored in a relational or other type of database along with account, identity and other information, in various embodiments.

The present subject matter describes a method of providing or authenticating the identity of an individual by matching device data stored by or accessible to the requestor and ASP. This may be a match of a single device or multiple devices, in various embodiments. The match may he calculated as a virtual certain as in the case of the requestor and ASP apps performing mutual authentication on the device. However, it may be less certain in the case of a device that only accesses the requestor or ASP via browser and does not contain an app from either.

Less than certain matches can also occur when there is a timing difference between the device data captured by the requestor and the ASP. For example, the requestor could capture a device fingerprint, then the device user could load a new piece of third-party software, and finally the ASP could capture a device fingerprint. The two device fingerprints may not be an exact match; however, they can still be a highly probable match. In this case, a score is assigned to the match such as a probability score in percentage terms that the match is correct, such as the identity match (IM) score discussed above. A match on more than one device improves the IM score, whereas a mismatch on a secondary device reduces the IM score, in various embodiments.

According to various embodiments, the requestor initiates a communication with the ASP and the two parties will compare Device Data. If both parties can reach the device or devices of the user in real-time, then real-time device data is used. Otherwise, cached data is used. Other attributes in the data score of the requestor and ASP, such as email address or other personal information, can also be used to evaluate the match. For example, a customer of the requestor may allege that their social security number (SSN) is a particular number. The requestor can send this to the ASP and this can be compared to the ASP's stored SSN for the user. Upon establishing a match, the ASP may return confidential information to the requestor if such release has been authorized by the subject individual. Alternatively, for privacy reasons the parties may not share customer confidential information. In order to maintain privacy, they may each transform the private data to mask the true value. If both parties transform the data using the same method and keys, then the data can still be compared although masked. Unmasked data may also be shared and compared though a trusted third party or private machine process, in various embodiments.

In various embodiments, the requestor initiates an identity verification request with multiple ASPs and considers the entirety of the responses in determining the probability of an identity match. The relationship between one or more ASPs and one or more requesters can be managed through an interchange, in an embodiment. This interchange can accept transaction information requests from a requestor and distribute the request to one or more ASPs based on a number of factors. Such factors can include the existence of pre-arranged relationships between the requestor and ASP, the likelihood that the ASP has data relevant to the request, and the cost that is charged by the ASP to fulfill the request. This interchange can establish and publish one or more application programming interfaces for the use of the parties. It may also provide a mechanism for pricing or bidding on ASP data by the requestor in a real-time manner, in various embodiments.

In one example, Jane Smith is a user of a public social media site. Assuming the social media site desires to provide a service to its members whereby they can authenticate their identity and appear as verified users of the site, the social media site may partner with a network of banks and government agencies that capture device data, in various embodiments. If, Jane submits a request to become a verified user by supplying confidential information to social media site, then additional information may be available. In an embodiment, the social media site sends the customer's alleged identity and known device data from the users' computers, tablets and mobile phones to an ASP interchange. The ASP interchange sees that Jane has a California driver's license. Assuming the California DMV is a participating ASP, the interchange sends Jane's device data, name, and driver's license number to the California DMV. The California DMV responds with an identity match score of 89%, and information on Jane's driver's license status, including infraction and accident history. In various embodiments, the interchange also sees that the social media site has provided an email address, so it sends Jane's device data, name and email address to the email provider. The email provider responds by providing detailed device data from its own records, and the interchange uses the data from the requestor and Google to create an identity match score for the request, in an embodiment. In addition, since Jane's data includes a bank checking account, the interchange may send Jane's device data, name, and encrypted SSN to the bank, which can return an additional identity match score and an indication of her credit worthiness. In various embodiments, the interchange may consider the identity match scores from the three ASPs and creates an aggregate identity match score, which it then returns to the social media site, along with other potentially useful data such as the driving data obtained from the DMV and the credit score obtained from the bank. If the identity match score or scores are above programmable thresholds, Jane's account is marked as verified. Other data provided by the ASPs can be used to make decisions about the disposition of Jane's account with the requestor, or her qualification for a loan or as a driver, in various embodiments.

In various embodiments, trusted third parties could receive proper consent from their customer to verify the customer's identity with the customer's financial institution, credit bureau, or other repository. Upon receiving a query from the third party, the same type of matching using device and other information as described above could produce a match probability. That match probability, along with the requested information, may be returned to the third party for use in the authentication decision. This subject matter may provide a more general authentication service wherein the parties are generalized, and the model may apply to authentication for any purpose and by any type of entity, by using device data as the key between entities to uniquely identify an individual user or account holder.

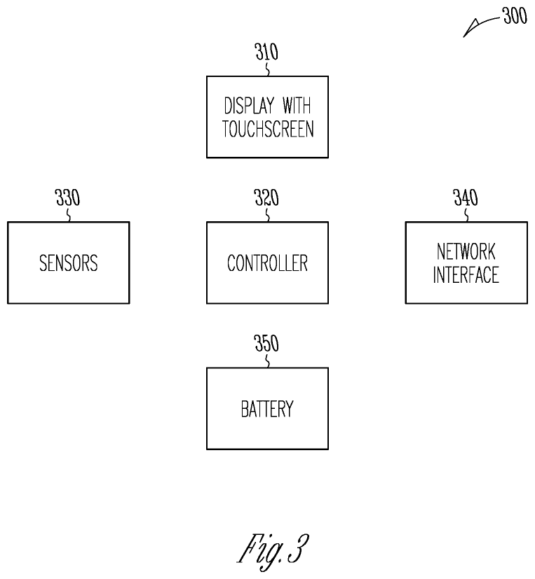

FIG. 3 illustrates an embodiment of computing device 300 used by a user to request a transaction that requires authentication. In the depicted embodiment, the computing device 300 includes a display with a touchscreen 310 interfaced with a controller or processor 320. The controller or processor 320 is electrically connected to one or more sensors 330, a network interface 340, and a battery 350 to supply power to the computing device 300, in various embodiments.

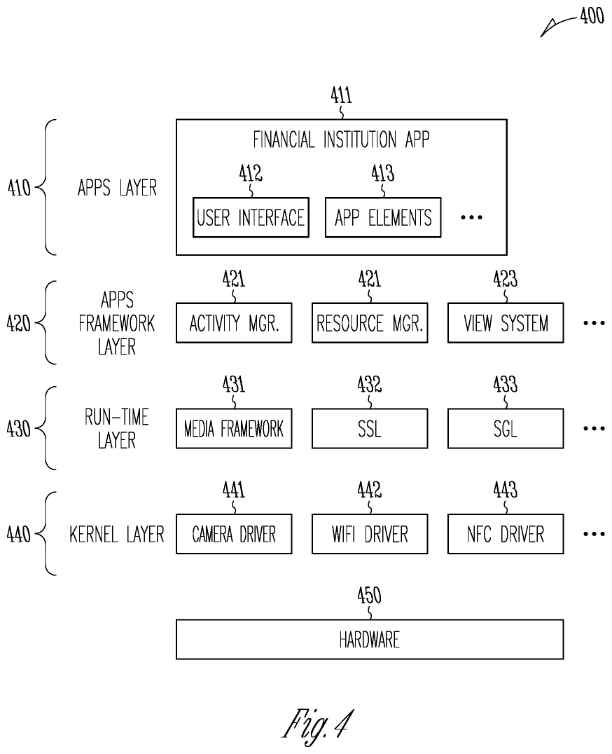

FIG. 4 illustrates an embodiment of a computing device 400 with a financial institution application 411. In various embodiments, the computing device 400 includes a mobile computing device such as a cellular telephone or smart phone. The depicted embodiment illustrates one example of software architecture executed on hardware 450, including one or more processors of the computing device 400. FIG. 4 is merely a non-limiting example of a software architecture and many other architectures can be implemented to facilitate the functionality described herein.

The representative hardware 450 comprises one or more processing units having associated executable instructions. Executable instructions represent the executable instructions of the software architecture, including implementation of the methods, modules, and components of the present subject matter. Hardware 450 also includes memory and/or storage modules, which also have executable instructions.

In the example architecture of FIG. 4, the software can be conceptualized as a stack of layers where each layer provides particular functionality. For example, the software can include layers such as an operating system, libraries, frameworks/middleware, applications and presentation layer. Other software architectures can include additional or different layers. The operating system can manage hardware resources and provide common services. The overall system can include, for example, a kernel layer 440, run-time layer 430, application framework layer 420 and application layer 410. The kernel layer 440 can act as an abstraction layer between the hardware and the other software layers. For example, the kernel layer 440 can be responsible for memory management, processor management (e.g., scheduling), component management, networking, security settings, and so on. The drivers can be responsible for controlling or interfacing with the underlying hardware. For instance, the drivers can include display drivers, camera drivers 441, Bluetooth® drivers, flash memory drivers, serial communication drivers (e.g., Universal Serial Bus (USB) drivers), Wi-Fi® drivers 442, near field communication (NFC) drivers 443, audio drivers, power management drivers, and so forth depending on the hardware configuration.

The run-time layer 430 can include a media framework 431, a secure sockets layer (SSL) 432 and a secure group layer (SGL) 433, in various embodiments. The application framework layer 420 can include an activity manager 421, a resource manager 422, and a view system application 423, in various embodiments. The application layer 410 can include built-in applications and/or third party applications. Examples of representative built-in applications can include, but are not limited to, a contacts application, a browser application, a book reader application, a location application, a media application, a messaging application, and/or a game application. Third party applications can include any of the built in applications as well as a broad assortment of other applications. In a specific example, the third party application (e.g., an application developed using the Android™ or iOS™ software development kit (SDK) by an entity other than the vendor of the particular platform) can be mobile software running on a mobile operating system such as iOS™, Android™, Windows® Phone, or other mobile operating systems. In this example, the third party application can invoke application programming interface (API) calls provided by the operating system to facilitate functionality described herein. A financial institution application 411 can implement the functionality of a mobile wallet application, in one embodiment. The mobile wallet application can be a built-in or third party application, and can include a user interface 412 and application elements 413 in various embodiments.

The applications in application layer 410 can utilize built in operating system functions (e.g., kernel, services and/or drivers), libraries, frameworks and middleware to create user interfaces to interact with users of the system. Alternatively, or additionally, in some systems interactions with a user can occur through a presentation layer. In these systems, the application/module “logic” can be separated from the aspects of the application/module that interact with a user.

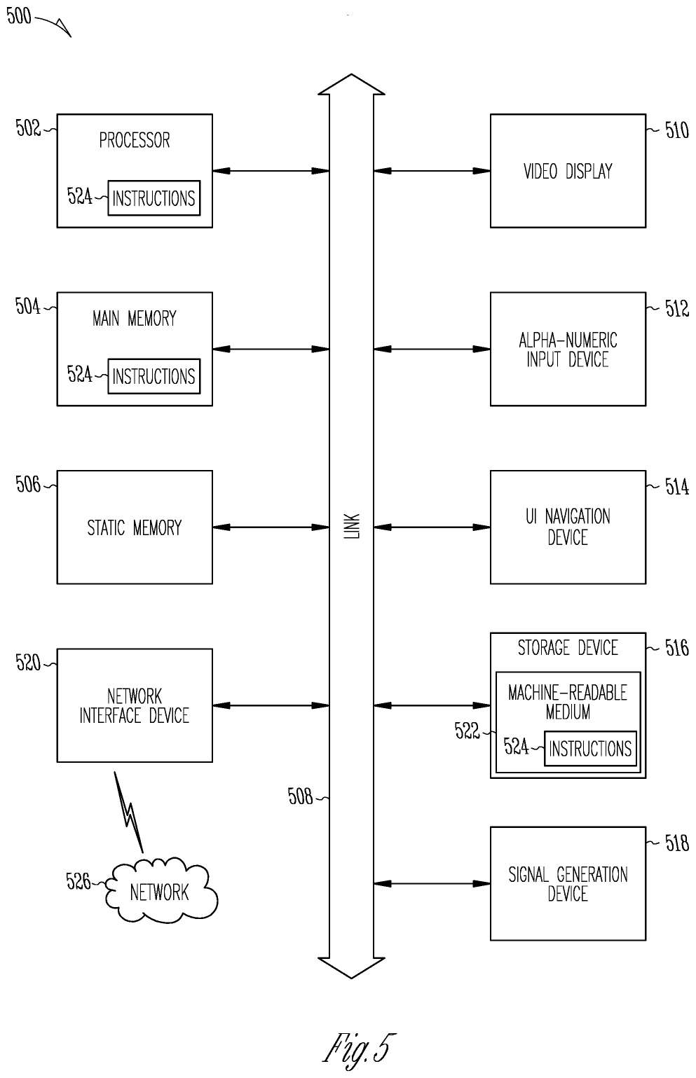

FIG. 5 is a block diagram illustrating a machine in the example form of a computer system 500, within which a set or sequence of instructions can be executed to cause the machine to perform any one of the methodologies discussed herein, according to an example embodiment. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a hybrid tablet, a set-top box (STB), a personal digital assistant (PDA), a mobile or cellular telephone such as a smart phone, a wearable device such as a smart watch, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 can further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 can additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The data storage device 516 includes a machine-readable medium 522 on which is stored one or more sets of data structures and instructions 524 (e.g., software) embodying or utilized by any one or more of the methodologies or functions described herein. The instructions 524 can also reside, completely or at least partially, within the main memory 504, static memory 506, and/or within the processor 502 during execution thereof by the computer system 500, with the main memory 504, static memory 506, and the processor 502 also constituting machine-readable media.

While the non-transitory computer-readable storage medium 522 is illustrated in an example embodiment to be a single medium, the term “machine-readable medium” or “computer-readable medium” can include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions (e.g., instructions 524) for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 can further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
receiving, by a processor of a computer located at a decision point, a request from a server located at an initiation point to authenticate a user to perform a transaction to purchase a product;
obtaining, using an internet communications protocol by the processor located at the decision point, device data from internet-enabled devices used by the user;
translating, by the processor located at the decision point, a merchant type identifier to a taxonomy of a third party source;
sending, by the processor located at the decision point, a third-party authorization inquiry to the third-party source using the translated merchant type identifier;
receiving, by the processor located at the decision point, third-party data from the third-party source in response to the third-party authorization inquiry, the third-party data including masked data transformed to mask a true value of the third-party data;
calculating, by the processor located at the decision point, a transaction consistency score using the device data and the third-party data, including:
calculating, using the third-party data, a value for variable L equal to a percent of the internet-enabled devices used by the user currently located within one hundred yards of a merchant location,
calculating a value for variable W equal to a number of web sites visited by the user over the last thirty days that include a type of the product being purchased in the transaction, and
calculating the transaction consistency score using an equation TC=q*(L)+r*(W), where TC is the transaction consistency score, and q and r are constants developed by the processor located at the decision point;
authenticating, by the processor located at the decision point, the user for the transaction using the transaction consistency score;
communicating, over a computer network by the processor located at the decision point to the server located at the initiation point, the authentication of the user for the transaction; and
performing, by the server located at the initiation point, the transaction for the user to purchase the product.

2. The method of claim 1, wherein receiving the third-party data includes receiving a first score generated by the third-party indicative of an identity match of the user and a second score generated by the third-party indicative of a degree to which the transaction aligns with the device data and other third-party customer and account data.

3. The method of claim 1, wherein the third-party data includes a received transaction consistency score generated by the third party.

4. The method of claim 1, wherein receiving the third-party data includes sending a query to the third party including data that comprise a match key to identify the user.

5. The method of claim 4, wherein sending a query to the third party includes sending a merchant type to identify a type of merchant requesting authentication.

6. The method of claim 1, comprising using an interchange configured to accept transaction information requests and distribute the requests to one or more third parties.

7. The method of claim 1, wherein receiving the third-party data includes receiving customer data stored by the third party.

8. The method of claim 1, wherein receiving the third-party data includes receiving account data stored by the third party.

9. The method of claim 1, wherein the device data includes personal profile information.

10. The method of claim 1, wherein the device data includes location information.

11. The method of claim 1, wherein the device data includes a device fingerprint.

12. The method of claim 1, wherein the device data includes interaction data including user activity on the internet-enabled devices.

13. A system comprising:
a computing device located at a decision point, the computing device comprising at least one processor and a data storage device in communication with the at least one processor, wherein the data storage device comprises instructions thereon that, when executed by the at least one processor, causes the at least one processor to:
receive, by the at least one processor, a request from a server located at an initiation point to authenticate a user to perform a transaction to purchase a product;
obtain, using an internet communications protocol by the at least one processor, device data from internet-enabled devices used by the user;
translate, by the at least one processor, a merchant type identifier to a taxonomy of a third party source;
send, by the at least one processor, a third-party authorization inquiry to the third-party source using the translated merchant type identifier;
receive, by the at least one processor, third-party data from the third-party source in response to the third-party authorization inquiry, the third-party data including masked data transformed to mask a true value of the third-party data;
calculate, by the at least one processor, a transaction consistency score using the device data and the third-party data, including:
calculating, using the third-party data, a value for variable L equal to a percent of the internet-enabled devices used by the user currently located within one hundred yards of a merchant location,
calculating a value for variable W equal to a number of web sites visited by the user over the last thirty days that include a type of the product being purchased in the transaction, and
calculating the transaction consistency score using an equation TC=q*(L)+r*(W), where TC is the transaction consistency score, and q and r are constants developed by the processor located at the decision point;
authenticate, by the at least one processor, the user for the transaction using the transaction consistency score;
communicate, over a computer network by the at least one processor to the server located at the initiation point, the authentication of the user for the transaction; and
perform, by the server located at the initiation point, the transaction for the user to purchase the product.

14. The system of claim 13, wherein the device data includes real-time device data from the user's internet-enabled devices and interactions by the user with internet-enabled devices.

15. The system of claim 13, wherein the device data includes historical data from the user's internet-enabled devices and interactions by the user with internet-enabled devices.

16. The system of claim 13, wherein the transaction includes a financial transaction.

17. A non-transitory computer-readable storage medium, the non-transitory computer-readable storage medium including instructions embodied on the non-transitory computer-readable medium that when executed by processors, cause the processors to perform operations of:
receiving a request from a server located at an initiation point to authenticate a user to perform a transaction to purchase a product;
obtaining device data from internet-enabled devices used by the user;
translating a merchant type identifier to a taxonomy of a third party source;
sending a third-party authorization inquiry to the third-party source using the translated merchant type identifier;
receiving third-party data from the at-least-one third-party source in response to the third-party authorization inquiry, the third-party data including masked data transformed to mask a true value of the third-party data;
calculating a transaction consistency score using the device data and the third-party data, including:
calculating, using the third-party data, a value for variable L equal to a percent of the internet-enabled devices used by the user currently located within one hundred yards of a merchant location,
calculating a value for variable W equal to a number of web sites visited by the user over the last thirty days that include a type of the product being purchased in the transaction, and
calculating the transaction consistency score using an equation TC=q*(L)+r*(W), where TC is the transaction consistency score, and q and r are constants developed by the processor located at a decision point;
authenticating the user for the transaction using the transaction consistency score;
communicating, over a computer network to the server located at the initiation point, the authentication of the user for the transaction and
performing, by the server located at the initiation point, the transaction for the user to purchase the product.

18. The non-transitory computer-readable storage medium of claim 17, wherein obtaining device data gathered by internet-enabled devices used by the user includes using an application installed by the user on the internet-enabled devices to capture and retain data during interactions with the user.

19. The non-transitory computer-readable storage medium of claim 17, wherein the third-party data includes a received transaction consistency score.

20. The non-transitory computer-readable storage medium of claim 17, wherein receiving the third-party data includes receiving a first score generated by the third-party indicative of an identity match of the user and a second score generated by the third-party indicative of a degree to which the transaction aligns with the device data.
